(19) United States
(12) Patent Application Publication
(10) Pub. No.: US 2014/0360875 A1
(43) Pub. Date: Dec. 11, 2014

(54) SENSOR

(71) Applicant: Robert Bosch GmbH, Stuttgart (DE)

(72) Inventor: Philipp Nolte, Gerlingen (DE)

(73) Assignee: Robert Bosch GmbH, Stuttgart (DE)

(21) Appl. No.: 14/293,598

(22) Filed: Jun. 2, 2014

(30) Foreign Application Priority Data
Jun. 7, 2013 (DE) 10 2013 210 612.2

(51) Int. Cl. G01N 27/406; G01N 27/407

(52) U.S. Cl. CPC G01N 27/4067; G01N 27/4071
USPC 204/424; 204/421

(57) ABSTRACT

A sensor includes a sensor element and a heating element for heating the sensor element. The sensor element has a front electrode, configured to be exposed to a substance which is to be measured, and a counterelectrode. Electrical contact can be made with the sensor element by electrical contact-making members. In one embodiment, the heating element has an electrically conductive heating structure. At least one of the electrically conductive heating structure, the front electrode, the counterelectrode, and at least one of the electrical contact-making members is constructed at least partially from a large number of particles which are connected to one another. The particles are formed at least partially from a noble metal or a noble metal alloy. A sensor of this kind, in particular a gas sensor or a particle sensor, allows improved production together with good performance.

This application claims priority under U.S.C. §119 to patent application number DE 10 2013 210 612.2, filed on Jun. 7, 2013 in Germany, the disclosure of which is incorporated herein by reference in its entirety.

### BACKGROUND

The present disclosure relates to a sensor, for instance a gas sensor, for example an exhaust gas sensor.

Sensors are required and used for a large number of applications. By way of example, sensors are used as exhaust gas sensors, for example as lambda probes, for instance binary lambda probes and broadband lambda probes, or else as nitrogen oxide sensors.

Sensors of this kind often comprise a sensor element as the active element and a heating arrangement which can heat the active sensor element of the sensor. In this case, electrodes are often used in the sensor elements, said electrodes being applied to an electrolyte and being in contact with a substance which is to be measured on account of the possible catalytic activity and the possible transportation of oxygen on the metal surface and furthermore with the electrolyte for introducing or removing oxygen. The materials of the electrodes therefore share the feature of resistance to oxidation or corrosion which is as high as possible, even at high temperatures.

It is therefore known that electrodes comprising noble metals are provided as electrode materials. Electrodes of this kind can then be sufficiently stable to corrosion, even at elevated temperatures.

### SUMMARY

The subject matter of the present disclosure is a sensor, having a sensor element and, in particular, a heating element for heating the sensor element, wherein the sensor element has a front electrode, which can be exposed to a substance which is to be measured, and a counterelectrode, wherein electrical contact can be made with the sensor element, in particular the front electrode and the counterelectrode, by electrical contact-making means, in particular wherein the heating element has an electrically conductive heating structure, wherein at least one of the electrically conductive heating structure, the front electrode, the counterelectrode and at least one of the electrical contact-making means is constructed at least partially from a large number of particles which are connected to one another, wherein the particles are formed at least partially from a noble metal or a noble metal alloy.

A sensor of this kind can be produced, in particular, in a cost-effective manner, wherein the selectivity and the sensitivity of the sensor are likewise high.

To this end, the sensor initially comprises a sensor element. In this case, a sensor element can be understood to mean, in a manner which is known per se, the active measuring element of the sensor. By way of example and in a non-limiting manner, a sensor element can be based on a configuration as is known per se to a person skilled in the art for gas sensors, for instance lambda probes or nitrogen oxide sensors. In this case, a sensor element of this kind can have a front electrode, which can be exposed to a substance which is to be measured, and a counterelectrode, wherein electrical contact can be made with the sensor element, in particular the front electrode and the counterelectrode, by electrical contact-making means. In this case, the counterelectrode can be configured, by way of example, as a back-electrode or else be arranged adjacent to the front electrode. In this case, the formulations “a front electrode” and “a counterelectrode” are intended to be understood in a non-limiting manner within the scope of the present disclosure. In a manner which is clearly identifiable by a person skilled in the art, only one front electrode or any desired number of front electrodes and/or only one counterelectrode or any desired number of counterelectrodes can therefore be provided, wherein the described feature can be provided in a suitable manner for in each case a front electrode and/or counterelectrode or for any desired large number of front electrodes and/or counterelectrodes. Purely by way of example, three to four electrodes can be provided for broadband lambda probes, for instance an inner pump electrode, outer pump electrode, Nernst electrode, reference electrode.

Therefore, for sensors of this kind, the front electrode can be configured in a manner which is known per se, in particular, to influence a variable electrical characteristic of the sensor element in the event of interaction with a substance which is to be measured, for instance a gas which is to be measured. In this case, the variable electrical characteristic can comprise, for example, a capacitance value, a conductance value or a resistance value of the sensor element. The characteristic can also be the measurement of a Nernst voltage or of a pump current through a thin-film ion conductor, wherein, for example, the voltage may be preferred in binary lambda probes and the current may be preferred for broadband lambda probes. In this case, the specific value may be dependent on the type and also on the concentration of the gas, so that both qualitative and also quantitative measurement is possible. In order to detect the specific value of the variable electrical characteristic, the electrical contact-making means can make contact with the front electrode and the counterelectrode with a corresponding measuring device.

Furthermore, the sensor or, for example, the sensor element has, in particular, a heating element for heating the sensor element. Said heating element can be used, in particular, to generate a constant measurement temperature. In this case, the optional heating element comprises, in particular, an electrically conductive heating structure. In this case, the heating structure as such can be the active part of the heating arrangement, and therefore apply, for instance, the heat which is required for heating purposes. In this case, an electrically conductive heating structure can be understood to mean, in particular, a structure of this kind which can have an electrical conductivity of, for example, in a region of a resistance of 5 ohms in such a way that, in particular, Joulean heat can be generated when a current is passed through, said heat being sufficient for the desired application or the desired heating capacity. It is clear from the above that the heating structure or its resistance value or the like can be matched to the desired field of application of the sensor, for which reason the exact configurations can vary greatly in a manner which is clear to a person skilled in the art.

In the case of a sensor as described above, provision is further made for at least one of the electrically conductive heating structure, the front electrode, the counterelectrode and one of the electrical contact-making means to be formed at least partially from a noble metal or a noble metal alloy. In this case, the electrically conductive heating structure, the front electrode, the counterelectrode and/or at least one of the electrical contact-making means is further constructed at least partially from a large number of particles which are connected to one another, wherein the particles are formed at least partially from a noble metal or a noble metal alloy.

The above-described structure comprising particles which are connected to one another, that is to say in particular connected to one another in an electrically conductive manner, allows significant advantages over a respectively solid configuration of the electrically conductive heating structure, the front electrode, the counterelectrode and the electrical contact-making means according to the prior art.

In respect of the particles, said particles are constructed at least partially from noble metal or a noble metal alloy. In this case, a noble metal alloy can be an alloy which contains a noble metal and at least one further metal or else a plurality of noble metals, for example can be formed only from noble metals.

In the first instance, a significant cost advantage can be achieved by the above-described configuration. Since, owing to said configuration, a compact configuration of the corresponding component, that is to say in particular the electrically conductive heating structure, the front electrode, the counterelectrode and at least one of the electrical contact-making means, is no longer provided, but this is replaced by particles which are connected to one another, material of the noble metal can be saved. Even when the particles are closely electrically connected to one another and, in the process, are arranged in a tight pack for instance, spaces which are not filled by noble metal or a noble metal alloy are further provided. As a result, a reduced quantity of costly noble metal is required in order to generate the corresponding structures.

However, in this case, the particles can be in close contact with one another in such a way that the electrically conductive properties or the thermal properties are not influenced or not significantly influenced in a negative manner, with the result that the performance of the sensor is further particularly high with respect to the production costs.

Furthermore, owing to the specific configuration of the particles, the physical arrangement of said particles and also the number of said particles, the electrically conductive heating structure, the front electrode, the counterelectrode and the electrical contact-making means can be matched to the desired field of application particularly easily.

In this case, given a corresponding configuration of the front electrode or the counterelectrode, the scope of the disclosure includes configurations of the components which belong to the electrode, such as, in particular, the active electrode structure, electrode supply lines and others, in a manner which is known to a person skilled in the art. The same applies for the purpose of the present disclosure for the heating structure and the contact-making means, which are also called contact pads.

In summary, the production costs can be significantly reduced and, furthermore, the performance can be kept high in a sensor which is configured in the manner described above.

Within the scope of one refinement, at least some of the particles, that is to say at least a portion of the existing particles, can have a core comprising an electrically conductive material and a sleeve which at least partially, in particular completely, surrounds the core and contains a noble metal or a noble metal alloy, wherein the noble metal or the noble metal alloy differ from the electrically conductive material of the core. A yet further improved reduction in costs and furthermore further improved matching to the desired field of application may be possible in this refinement.

In particular, it is possible for only the sleeve to be formed from, for example composed of, a noble metal or a noble metal alloy. Therefore, only a very small proportion of the corresponding component has to be produced from a costly material. In this case, the core can be produced from any desired electrically conductive material, for example metal, which may be considerably more cost-effective than, in particular, a noble metal or a noble metal alloy. In this case, the core only requires a certain temperature stability up to the operating region of the sensor and an electrical conductivity, which is correspondingly good, for the electrodes or contact-making means, or is sufficiently low, for the heating structure. In this case, the exact values of the desired conductivity can be selected depending on the desired field of application and the desired performance data. In this case, continuous thermal and electrical conductivity can be established, in particular, by a permanent connection of the particles to one another. In this case, the conductivity can be established both by means of the material of the sleeves and also the material of the cores.

Furthermore, owing to the sleeve at least partially, preferably completely, encasing the core, the core can be protected against the influences of the measurement conditions during use of the sensor. The stability of the particles in relation to corrosive attacks, for example, can also be maintained even with less stable core materials.

Furthermore, in the case of the above-described particle structure, which can also be called a core-shell particle, contact between the noble metal or the noble metal alloy and the substance or substances which is/are to be detected and with an electrolyte is maintained, with the result that the interaction with the component which is to be detected and with the electrolyte, and therefore the performance of the sensor, is not restricted. Therefore, for detection, in a manner comparable to solid electrodes, for example, catalytic activity of the noble metal or the noble metal alloy for a catalytic reaction with the component which is to be detected can be possible and also diffusion of gases, for instance of oxygen, into the surface of the sleeve can be maintained.

Particles of this kind can be produced, for example, using the process as described in M. Neergat, J. Electrochem. Soc., 2012, vol. 159, Issue 7. By way of example, the particles having a core and a sleeve comprising a material which is preferably different from the core can be produced as follows. A metal salt can be reduced in a solution, as a result of which the pure metal is produced as the core. The metal of the sleeve can then be added as a salt, following which said salt reduces on the surface of the, for example, less noble core metal and is deposited on the surface of the core. As an alternative, cores of a suitable size can be coated by, for example, physical or chemical deposition methods which are known per se.

Within the scope of a further refinement, the core can have a metal which is selected from the group comprising copper (Cu), titanium (Ti), chromium (Cr), manganese (Mn), iron (Fe), cobalt (Co), nickel (Ni), zirconium (Zr), molybdenum (Mo), tungsten (W) and osmium (Os), wherein the abovementioned metals may be suitable, by way of example, using platinum or rhodium as sleeve material and in the process can be accompanied, at least in some cases, by a significant cost advantage, for example in comparison to platinum. Further materials for the core include vanadium (V) and tantalum (Ta) which can likewise allow a cost saving and which may be advantageous, by way of example, in combination with palladium (Pd) as the material for the sleeve. Furthermore, the core can be formed from silver which can be distinguished by price, conductivity and oxidation stability. Furthermore, alloys containing one or more of the abovementioned metals may be suitable as core material. As an alternative or in addition, the sleeve can contain a metal which is selected from the group comprising platinum (Pt), rhodium (Rh), palladium (Pd) or an alloys containing one or more of the abovementioned metals.

In particular, copper is particularly advantageously suitable as the core material since it has a good electrical conductivity and therefore can particularly advantageously allow a good performance of the sensor.

Furthermore, copper has a comparatively low cost factor, with the result that there may also particularly advantageously be a reduction in costs. Furthermore, in particular, platinum as a single material of the sleeve or else as a constituent of an alloy can advantageously be suitable since it is suitable a suitable activity for interaction with components, which are to be detected, for a large number of sensors, in particular for gas sensors. Furthermore, platinum has a good stability, with the result that it may be particularly well suited as the sleeve and therefore as a protection means for the core.

In the case of a heating structure, the desired high or low conductivity can further be adjusted by means of the macroscopic geometries of the conductor track. Owing to variation in the size of the core or sleeve or owing to the selection of the metals or materials, it is also possible to vary the temperature coefficients of the electrical resistor of the heater.

Within the scope of a further refinement, the sleeve can have a thickness which is in a region of greater than or equal to the thickness of one atomic layer of the corresponding noble metal or of the noble metal alloy. Thicknesses of this type can, under certain circumstances, already be sufficient to achieve a sufficient degree of corrosion stability. The ability to produce such thin metal layers or alloy layers is known to a person skilled in the art, in principle, under the terms “ultra-thin metal films” or “surface alloys” in particular (in the case of alloys).

Within the scope of a further refinement, the ratio of the core radius to the particle radius can be in a region of greater than or equal to 0.25. In other words, the ratio of the radius r of the inner core to the radius R of the entire particle sleeve r/R can be ≧0.25, in particular in a region of greater than or equal to 0.5, for example greater than or equal to 0.9. Exemplary and non-limiting examples of suitable layer thicknesses of the sleeve comprise, in this case, values in a region of approximately 10 nm and/or 100 nm of the entire particle. Accordingly, the ratio of the thickness d of the sleeve to the radius of the core d/r can be in a region of less than or equal to 3. In this case, the abovementioned values in the case of uneven thicknesses in each case relate to the average values of the radii or of the thicknesses. In this refinement, it is possible to achieve, in particular, the advantage of a very good electrical performance even at high temperatures together with cost-effective production.

Particularly in this refinement, a suitable protective action for the core can already be developed particularly when the sleeve completely encases or encloses the core. However, in this case, the layer can further have such a thinness that the costs of the sensor can be particularly effectively reduced.

Within the scope of a further refinement, at least some of the particles, that is to say at least a portion of the existing particles, can be of homogeneous configuration in respect of their material composition. In this refinement, the particles therefore do not, or at least do not all, that is to say not all of the existing particles, have a structure comprising a core and a sleeve, but instead are rather of homogeneous configuration and therefore comprise only one material or one material composition along their diameter, can be composed, in particular, of one material, such as a noble metal or a noble metal alloy. In this refinement, it is possible to carry out, in particular, the production method in a particularly simple manner, with the result that a noticeable cost saving in comparison to compact components is also possible in this refinement. Furthermore, this refinement can be advantageous under particularly harsh or aggressive detection conditions which, under certain circumstances, could lead to the sleeve being damaged in spite of its fundamental stability. This is because, in this refinement, no core comprising a comparatively unstable material is exposed, but rather the desired stability of all of the particles is maintained even in the event of damage to the surface.

Within the scope of a further refinement, the particles can have a diameter D50 in a range of from greater than or equal to 1.5 nm to less than or equal to 1 mm Particularly in this refinement, it may be possible to produce the corresponding component structures in a particularly simple manner by sophisticated methods. Furthermore, the particles can be arranged in a very tight arrangement in relation to one another, so that the performance of the sensor is particularly good and furthermore a pronounced cost saving is possible.

Within the scope of a further refinement, the particles can have a multimodal size distribution. In this case, a multimodal size distribution is intended to mean, in particular, that the particles have a bimodal, trimodal or multimodal size distribution. In the case of a bimodal size distribution, for example, the packing density can optionally be increased by the relatively large particles forming a kind of framework or matrix with hollow spaces, wherein the smaller particles serve as a kind of “filling material” and can be arranged in the hollow spaces. As a result, the volumes of the hollow spaces are reduced, this additionally restricting the area affected by corrosion to the “macroscopically outer” region of the heater/contact pad. A possible, but non-limiting, diameter of the relatively small particles in the case of an exemplary bimodal distribution is approximately 10% of the diameter of the relatively large particles. In this case, all of the particles can have the above-described configuration having a sleeve and a core or homogeneous cores.

As an alternative, provision can be made for particles with a multimodal size distribution to be present in such a way that the relatively small particles are formed only from the sleeve material of the relatively large particles or from the core material of the relatively large particles. This may already suffice since, in the case of comparatively small particles, the savings potential is lower. In this case, the selection of the configuration of the respective particles can be selected depending on the respective size.

Furthermore, it may be advantageous, particularly in the case of electrode materials, for the catalytic activity of the electrode to be improved by the size dependence of the catalytic activity of, for example, nanoparticles being utilized.

Within the scope of a further refinement, the particles can form a particle composite, in particular wherein the particle composite has a size which is in a range of greater than or equal to 0.3 μm to less than or equal to 3 mm. In other words, the particles which form the particle composite can be present in the above-described size, but, in this case, the particle composite can be correspondingly larger. Particle composites of this kind can be processed, for example, to form an electrode structure substantially using methods which are comparable to those for forming particles, but can have further advantages in this case. For example, particle composites of this kind can have a reduced toxicity. Furthermore, electrodes which can be generated in this refinement can be better matched, for example, in respect of their properties and processing to existing electrodes without nanostructured configurations, this making replacement easier. In this case, in order to produce composites of this kind, a particle composite having a large number of particles can be sintered, for example, in a closed system and then be ground to a suitable size. The particles which form the particle composite can again be of homogeneous configuration or have a structure with a core and a sleeve. In this refinement, the features described above and below for the particles can therefore, in particular, for the small particles which form the particle composite.

Within the scope of a further refinement, the particles and possibly the particle composite can be sintered. A high stability of the particle structure is possible, in particular, by sintered particles since the individual particles adhere firmly to one another. In this case, the latter can equally lead to the performance of the corresponding component and therefore of the entire sensor being particularly high. Furthermore, it is possible, in particular by sintering the particles, to achieve an overall structure with a high degree of gastightness, this possibly being advantageous particularly for gas sensors. In this case, the desired structure can be provided, for example, as a paste of particles which are dispersed in a solvent, said paste being applied, for example knife-coated or printed, onto a substrate, for instance onto an electrolyte in the case of the electrode or onto a ceramic substrate, and then being subjected to a sintering process under elevated temperature, in order to obtain the final structure.

Within the scope of a further refinement, the sensor can be a gas sensor or a particle sensor, in particular an exhaust gas sensor. The above-described sensor can be advantageously suitable particularly for exhaust gas sensors since sensors of this kind often require noble metals or noble metal alloys as catalytically active substances which, therefore, allow a high cost saving. Non-limiting examples of exhaust gas sensors are, in this case, sensors which are arranged in the exhaust gas section of a vehicle, for example a gas sensor for characterizing the residual oxygen content in combustion gases, in particular binary and broadband lambda probes, particle sensors or nitrogen oxide sensors (NOx) sensors.

### BRIEF DESCRIPTION OF THE DRAWINGS

Further advantages and advantageous refinements of the subjects according to the disclosure are illustrated by the drawings and explained in the following description. It should be noted here that the drawings are only descriptive and are not intended to restrict the disclosure in any way. In the drawings

FIG. 1 is a schematic illustration of an electrolyte structure in which various configurations of particles for generating a sensor according to the disclosure are arranged; and

FIG. 2 is a schematic view of a section through an electrically conductive layer having particles with cores and sleeves.

### DETAILED DESCRIPTION

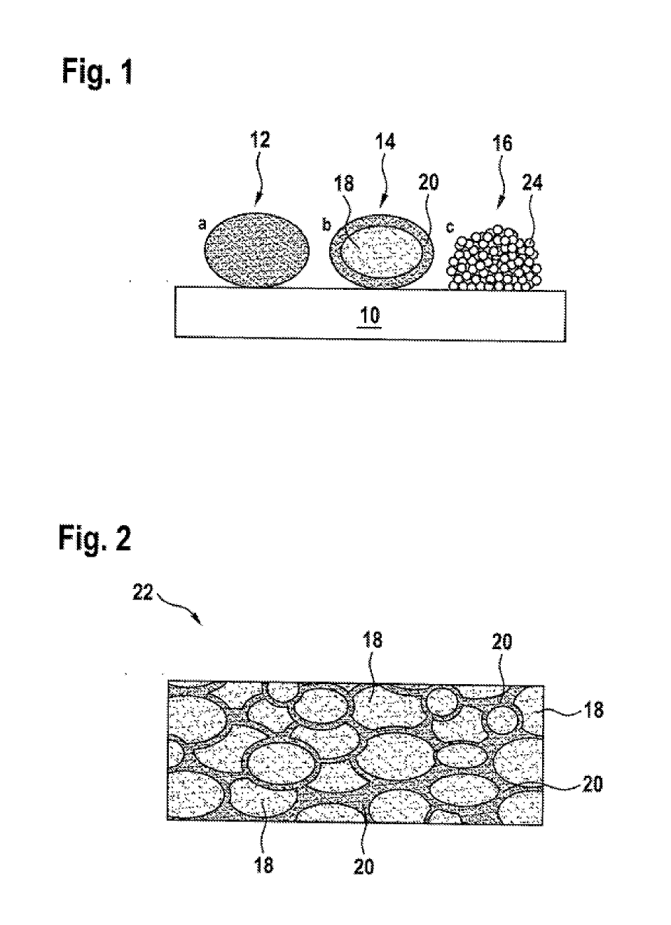

FIG. 1 shows an electrolyte 10 on which, by way of example, particles 12, 14, 24 are shown, it being possible, according to FIG. 1, for said particles to be configured as electrodes of a sensor.

A sensor which is to be generated in this way comprises a sensor element and, in particular, a heating element for heating the sensor element, wherein the sensor element has a front electrode, which can be exposed to a substance which is to be measured, and a counterelectrode, wherein electrical contact can be made with the sensor element, in particular the front electrode and the counterelectrode, by electrical contact-making means, wherein the heating element has an electrically conductive heating structure. Particles 12, 14, 24 are shown purely by way of example in FIG. 1, said particles being arranged on the electrolyte 10 and, in this case, being able to form an electrode structure, particularly when a large number of particles 12, 14 or 24 of this kind are provided. In a manner which is clear to a person skilled in the art, the shown particles can, in a large number which are connected to one another, equally form a contact-making means or a heating structure.

The particle 12 which is shown in FIG. 1 is of homogeneous configuration in respect of its material composition and comprises, according to FIG. 1, only one material, for example platinum.

The particle 14 which is shown in FIG. 1 has a core 18 comprising an electrically conductive material and a sleeve 20 which at least partially surrounds the core 18 and contains a noble metal or a noble metal alloy. In this case, the core 18 can contain a metal which is selected from the group comprising copper (Cu), titanium (Ti), chromium (Cr), manganese (Mn), iron (Fe), cobalt (Co), nickel (Ni), zirconium (Zr), molybdenum (Mo), tungsten (W), osmium (Os), vanadium (V) and tantalum (Ta), silver (Ag) or an alloy containing at least one of the abovementioned metals, and/or the sleeve 20 can contain a metal which is selected from the group comprising platinum (Pt), rhodium (Rh), palladium (Pd) or an alloys containing at least one of the abovementioned metals. Furthermore, the sleeve can have a thickness which is in a region of greater than or equal to one atomic layer.

A section through a layer comprising particles 14, for example forming an electrode structure 22, or else a contact-making means or else a heating element, is shown in FIG. 2. It can be seen that the cores 18 are connected to one another by the sleeves 20, for example by a sintering process. In this case, free spaces corresponding to the packing of the particle can remain open, or all of the free spaces can be closed by noble metal or a noble metal alloy.

The particles 24 which are shown in FIG. 1 further form a particle composite 16 which is therefore formed from the particles 24. In this case, the particles 24 can be formed as homogeneous particles 12 or preferably as particles 14 having the core 18 and the sleeve 20.

In principle, the particles 12, 14, 24 can have a diameter D50 in a range of from greater than or equal to 1.5 nm to less than or equal to 1 mm, wherein, in particular, the particle composite 16, which is formed by a large number of particles 24, can have a size which is in a range of from greater than or equal to 0.3 μm to less than or equal to 1 mm. Furthermore, the particles 12, 14, 24 can have a multimodal size distribution in the finished structure.

What is claimed is:

1. A sensor, comprising:
a sensor element including a front electrode, configured be exposed to a substance which is to be measured, and a counterelectrode; and
a heating element configured to heat the sensor element,
wherein electrical contact can be made with the sensor element by electrical contact-making members,
wherein at least one of the heating element, the front electrode, the counterelectrode, and one of the electrical contact-making members is constructed at least partially from a large number of particles which are connected to one another, and
wherein the particles are formed at least partially from one of a noble metal and a noble metal alloy.

2. The sensor according to claim 1, wherein at least some of the particles include:
a core including an electrically conductive material; and
a sleeve configured to at least partially surround the core, the sleeve containing one of a noble metal and a noble metal alloy.

3. The sensor according to claim 2, wherein the core contains a metal selected from copper, titanium, chromium, manganese, iron, cobalt, nickel, zirconium, molybdenum, tungsten, osmium, vanadium and tantalum, silver or an alloy containing at least one of the abovementioned metals.

4. The sensor according to claim 2, wherein the ratio of the core radius to the particle radius is greater than or equal to approximately 0.25.

5. The sensor according to claim 1, wherein at least some of the particles are of homogeneous configuration in respect of material composition.

6. The sensor according to claim 1, wherein the particles have a diameter greater than or equal to approximately 1.5 nm and less than or equal to approximately 1 mm.

7. The sensor according to claim 1, wherein the particles have a multimodal size distribution.

8. The sensor according to claim 1, wherein the particles form a particle composite.

9. The sensor according to claim 1, wherein the particles are sintered.

10. The sensor according to claim 1, wherein the sensor is a gas sensor or a particle sensor.

11. The sensor according to claim 1, wherein electrical contact can be made with the front electrode and the counterelectrode.

12. The sensor according to claim 1, wherein the heating element has an electrically conductive heating structure.

13. The sensor according to claim 2, wherein the sleeve contains a metal selected from platinum, rhodium, palladium or an alloy containing at least one or more of the abovementioned metals.

14. The sensor according to claim 3, the sleeve contains a metal selected from platinum, rhodium, palladium or an alloy containing at least one or more of the abovementioned metals.

15. The sensor according to claim 8, wherein the particle composite has a size which is greater than or equal to 0.3 μm and less than or equal to 3 mm.
